(19) United States
(12) Patent Application Publication
(10) Pub. No.: US 2007/0168293 A1
(43) Pub. Date: Jul. 19, 2007

(54) Method and apparatus for authorizing rights issuers in a content distribution system

(76) Inventor: Alexander Medvinsky, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/316,493

(22) Filed: Dec. 22, 2005

Related U.S. Application Data
(60) Provisional application No. 60/686,670, filed on Jun. 2, 2005.

(51) Int. Cl. G06Q 99/00; H04L 9/00

(52) U.S. Cl. 705/57

(57) ABSTRACT

Method and apparatus for rights issuer authorization in a content distribution system is described. In one example, a message is received at a client device from a first rights issuer. A digital certificate is obtained for the first rights issuer. The digital certificate is processed to verify the first rights issuer as being rights issuer authorizing. The message is processed to identify at least one rights issuer identifier. The client device is configured to receive rights objects from at least one rights issuer corresponding to the at least one rights issuer identifier, respectively.

### CROSS-REFERENCE TO RELATED APPLICATIONS

This application claims benefit of U.S. provisional patent application Ser. No. 60/686,670, filed Jun. 2, 2005, which is incorporated by reference herein.

### BACKGROUND OF THE INVENTION

1. Field of the Invention

The present invention relates to content distribution systems and, more particularly, to a method and apparatus for authorizing rights issuers in a content distribution system.

2. Description of the Background Art

Digital content has gained wide acceptance in the public. Such content includes, but is not limited to: movies, videos, music, and the like. Consequently, many consumers and businesses employ various digital media devices or systems that enable the reception of such digital multimedia content via several different communication channels (e.g., a wireless link, such as a satellite link, or a wired link, such as a cable connection). Similarly, the communication channel may also be a telephony based connection, such as DSL and the like. Regardless of the type of channel, the digital content and/or the distribution of the digital content is typically secured using a conditional access (CA) mechanism and a digital rights management (DRM) mechanism (e.g., encryption/decryption using keys).

Presently, specifications are being developed with respect to the distribution of content and services over wireless communication networks. One such set of standards is being developed by the Open Mobile Alliance (OMA). In the OMA DRM protocol, for example, digital content (e.g., a movie or song) is associated with a rights object (RO). The RO provides granting rights to a client device for viewing the digital content. A client device obtains an RO from a rights issuer (RI). Present DRM protocols, such as the OMA DRM protocol, do not specify how a DRM client should be configured so that it accepts ROs only from RIs that have been authorized by a particular operator. As such, a client device may obtain ROs to view protected digital content from an unauthorized source. Accordingly, there exists a need in the art for a method and apparatus for authorizing issuers of rights objects in a content distribution system.

### SUMMARY OF THE INVENTION

Method and apparatus for rights issuer authorization in a content distribution system is described. In one embodiment, a message is received at a client device from a first rights issuer. A digital certificate is obtained for the first rights issuer. The digital certificate is processed to verify the first rights issuer as being rights issuer authorizing. The message is processed to identify at least one rights issuer identifier. The client device is configured to receive rights objects from at least one rights issuer corresponding to the at least one rights issuer identifier, respectively.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a content distribution system in accordance with one or more aspects of the invention;

FIG. 2 is a flow diagram depicting an exemplary embodiment a method for authorizing rights issuers in a content distribution system in accordance with one or more aspects of the invention;

FIG. 3 is a flow diagram depicting an exemplary embodiment of a method for obtaining and viewing protected content in accordance with one or more aspects of the invention; and

FIG. 4 is a block diagram depicting an exemplary embodiment of a computer suitable for implementing the processes and methods described herein.

To facilitate understanding, identical reference numerals have been used, where possible, to designate identical elements that are common to the figures.

### DETAILED DESCRIPTION OF THE INVENTION

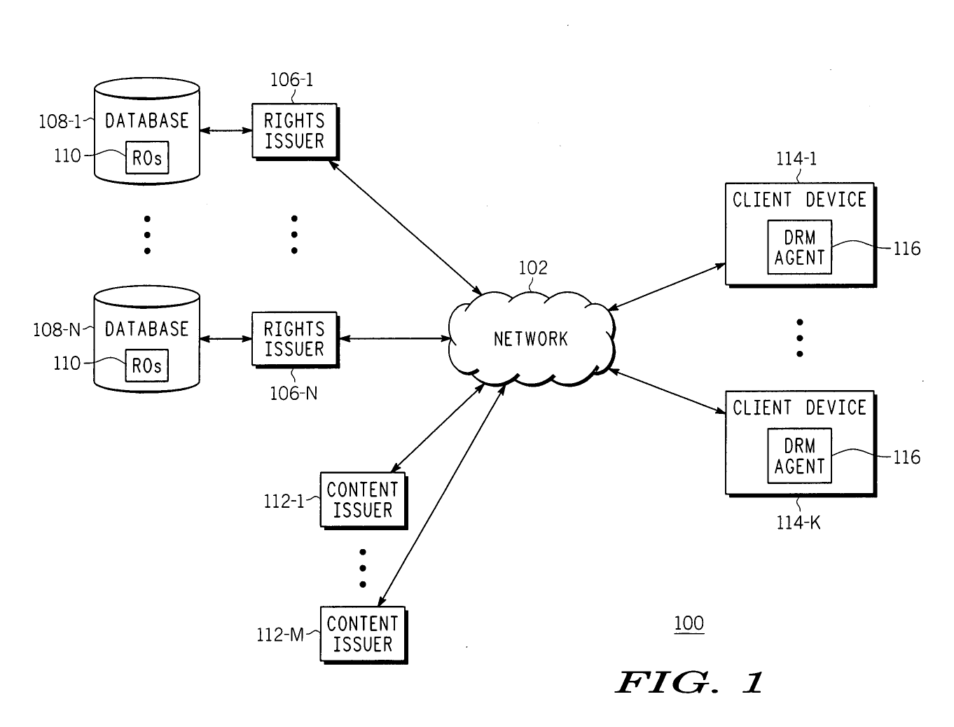

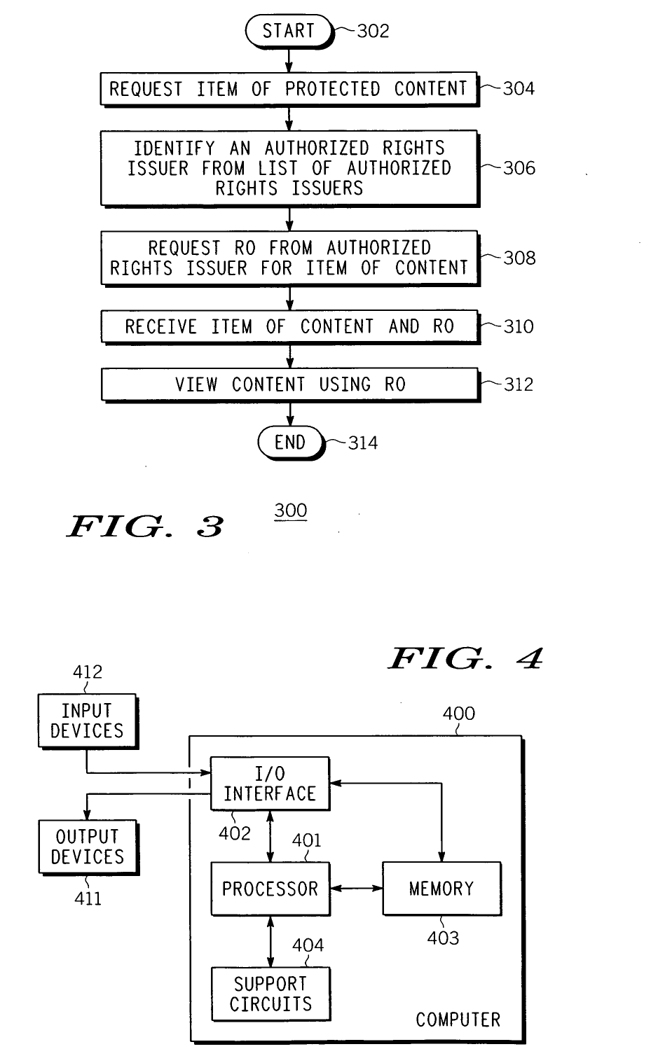

FIG. 1 is a block diagram of a content distribution system 100 in accordance with one or more aspects of the invention. The system 100 includes a network 102, rights issuers (RIs) 106-1 through 106-N (collectively referred to as RIs 106), content issuers (CIs) 112-1 through 112-M (collectively referred to as CIs 112), and client devices 114-1 through 114-K (collectively referred to as client devices 114). The variables N, M, and K are each an integer greater than zero. The network 102 includes a wired network, wireless network, or any combination of wireless and wired networks. For example, the network 102 may include one or more of a local area network (LAN), wireless LAN (WLAN), cellular network, or any combination of such networks. In general, the network 102 facilitates communication between the RIs 106, the CIs 112, and the client devices 114. The RIs 106 and the CIs 112 may comprise servers, such as the server 300 of FIG. 3 described below. Those skilled in the art will appreciate that a RI and a CI may be logically separate parts of a single server.

Each of the CIs 112 is configured to deliver protected content to the client devices 114. The protected content may include any type of digital content known in the art, such as software, ring tones for a cellular phone, digital photographs, music clips, video clips, streaming media, and the like. The protected content is cryptographically protected when distributed by the CIs 112 using any type of encryption algorithm known in the art. The protected content is associated with a content encryption key, which is required for access.

Each of the RIs 106 is configured to distribute rights objects (ROs) to the client devices 114. The RIs 106-1 through 106-N may be coupled to databases 108-1 through 108-N, respectively. Each of the databases 108 stores data that can be used to issue ROs for the protected content distributed to the client devices 114 (“rights data 110”). The rights data 110 may include content encryption key data and permission data associated with the protected content. The content encryption key data includes content encryption keys for access particular items of protected content. The permission data includes various permissions associated with particular items of protected content, such as whether or not the content can be played, displayed, or executed by the client device, as well as the number of times or the length of time the content can be played, displayed, or executed.

Each of the client devices 114 includes a digital rights management (DRM) agent 116. The DRM agent 116 is configured to manage the conditional access to protected content for the client device. To access a particular item of protected content, the DRM agent 116 communicates with an RI to request and obtain an RO associated with the protected content. The issued RO includes the appropriate permissions for accessing the protected content, as well as a content encryption key for decrypting the protected content. In an RO, the sensitive portions (e.g., content encryption key) may be encrypted and associated with a rights encryption key. The rights encryption key is cryptographically bound to the target DRM agent (i.e., only the target DRM agent can access the rights encryption key).

For each of the client devices 114, the DRM agent 116 employs DRM security protocols to control communication with an RI. Notably, the DRM agent 116 employs a registration protocol for registering with an RI and an RO protocol for requesting and acquiring ROs from an RI with which the DRM agent 116 is registered. In one embodiment, the DRM agent 116 employs a rights object acquisition protocol (ROAP), as described in the OMA DRM specification. The registration protocol is a security information exchange and handshake between an RI and a client device. Successful completion of the registration process between a client device and an RI allows the client device to request and obtain ROs from the RI using the RO protocol. The RO protocol provides for mutual authentication of client device and RI and the secure transfer of ROs.

Each of the client devices 114 is provisioned with a device public/private key pair and an associated digital certificate, signed by an appropriate authority, which identifies the client device and certifies the binding between the client device and its key pair. In addition, each of the RIs 106 is provided with a public/private key pair and one or more digital certificates. During a particular DRM security protocol (e.g., registration), one or more messages between the DRM agent 116 of a client device and an RI result in the exchange of digital certificates. The one or more messages may be digitally signed by the sender using an appropriate private key and authenticated by the recipient using an appropriate public key obtained from an appropriate digital certificate. In this manner, the RI authenticates a requesting client device, and the requesting client device authenticates the RI.

Requests for registration and ROs may be initiated by the DRM agent 116 in the client device. Alternatively, an RI may send a trigger message to the DRM agent in a client device. In the embodiment where the ROAP protocol is employed, the trigger messages are known as ROAP triggers. The trigger message causes the exchange of digital certificates and mutual authentication between the target DRM agent and the ARI 104. In accordance with an embodiment of an invention, the DRM agent 116 in each of the client devices 114 is configured to accept trigger messages only from authorized RIs, referred to as authorizing rights issuers (ARIs). Thus, one or more of the RIs 106 are configured as ARIs. The DRM agent 116 in each of the client devices 114 will reject trigger messages from RIs that are not authorized to send such trigger messages. The trigger messages received from an ARI will configure a client device with one or more authorized RIs with which the client device can communicate to receive ROs. These trigger messages are referred to herein as “RI-authorizing trigger messages.” In one embodiment, a client device only sends RO requests to RIs that have been identified as being authorized by a particular ARI.

For example, assume the RI 106-1 is the only ARI. The RI 106-1 is configured to send trigger messages to the client devices 114 through the network 102. Assume the client device 114-1 receives a trigger message from the RI 106-1. The trigger message is signed by the RI 106-1. The client device 114-1 authenticates the trigger message using the digital certificate chain for the RI 106-1. The certificate chain of the RI 106-1 may be included in the trigger message itself. A device may save the certificate chain of the RI 106-1 for future use, so that subsequent trigger messages from the RI 106-1 may contain just an identifier for the certificate (e.g., hash of the public key). The client device 114-1 is then able to find the certificate of the RI 106-1 in its local certificate store. The client device 114-1 may validate the digital certificate for the RI 106-1 using conventional public key infrastructure (PKI) techniques known in the art. The DRM agent 116 in the client device 114-1 then parses the digital certificate for the RI 106-1 to determine whether a predefined field in the certificate has a predefined value. If the predefined field has the predefined value, the RI 106-1 is authorized to send RI-authorizing trigger messages.

For example, the digital certificate may include a subject name section having the following attribute:

OrganizatoinalUnitName=<RI subsidiary/location>

If the OrganizationalUnitName is set to a predefined value, such as “Device Configuration”, then the certificate indicates that its RI is authorized to send RI-authorizing trigger messages. Only those RIs 106 that are configured to send RI-authorizing trigger messages include an OrganizationalUnitName attribute set to Device Configuration.

Having verified that the RI 106-1 is authorized to send RI-authorizing trigger messages, the client device 114-1 can parse the message received from the RI 106-1 to obtain one or more identifiers of authorized RIs (“RI identifiers”). In one embodiment, each RI identifier is a hash of a public key for a given RI. The client device 114-1 can also authenticate and parse additional RI-authorizing trigger messages sent from the RI 106-1 to obtain additional RI identifiers. In this manner, the client devices 114 are configured with a set of authorized RIs from which they can obtain ROs for protected content. The client devices 114 will not attempt to obtain ROs from unauthorized RIs, nor will the client devices 114 accept ROs or trigger messages from unauthorized RIs.

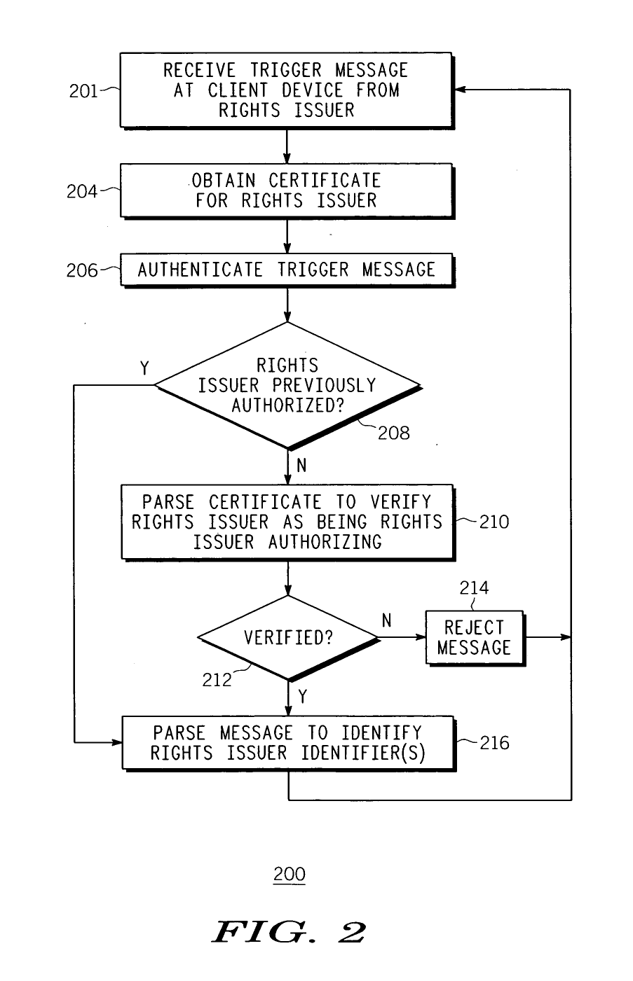

FIG. 2 is a flow diagram depicting an exemplary embodiment a method 200 for authorizing rights issuers in a content distribution system in accordance with one or more aspects of the invention. The method 200 begins at step 202, where a trigger message is received at a client device from an RI. At step 204, a digital certificate is obtained for the RI. The client device verifies the digital certificate using a well known PKI technique. At step 206, the trigger message is authenticated using a public key from the digital certificate. At step 208, a determination is made whether the RI was previously authorized to send RI-authorizing trigger messages. That is, a determination is made whether the RI is a valid ARI. If so, the method 200 proceeds to step 216, discussed below. Otherwise, the method 200 proceeds to step 210.

At step 210, the digital certificate is parsed to verify the RI as being RI-authorizing. That is, certificate is processed to verify that the RI is a valid ARI permitted to transmit RI-authorizing trigger messages. As described above, the certificate may include a predefined field indicative of whether the RI is RI-authorizing. At step 212, a determination is made whether the RI was verified as being RI-authorizing. If no, the method 200 proceeds to step 214, where the message is rejected at the client device. The method 200 then returns to step 202 and repeats when another trigger message is received at the client device. If the RI is verified as being RI-authorizing at step 212, the method 200 proceeds to step 216. At step 216, the message is parsed to identify one or more RI identifiers. Each identifier obtained at step 216 relates to an RI from which the client device is authorized to request and receive ROs. The method 200 returns to step 202 and repeats for another received trigger message.

FIG. 3 is a flow diagram depicting an exemplary embodiment of a method 300 for obtaining and viewing protected content in accordance with one or more aspects of the invention. The method 300 begins at step 302. At step 304, an item of content is requested by a client device. The client device may request an item of content from a CI, for example. At step 306, an authorized RI is identified from a list of authorized RIs in the client device. The identities of such authorized RIs are obtained using the method 200 of FIG. 2. At step 308, an RO is requested from the authorized RI for the item of content. At step 310, the item of content and the RO is received at the client device. Notably, the item of content may be received before, after, or at the same time as the RO. The item of content may be received even before the corresponding RO has been requested. At step 312, the item of content is view using the RO. The method 300 ends at step 314.

FIG. 4 is a block diagram depicting an exemplary embodiment of a computer 400 suitable for implementing the processes and methods described herein. The computer 400 may be used to implement an RI, a CI, or both an RI and a CI, as described above. The computer 400 may also be used to implement a DRM agent in a client device, and thus perform all or portions of the methods 200 and 300. The computer 400 includes a processor 401, a memory 403, various support circuits 404, and an I/O interface 402. The processor 401 may be any type of microprocessor known in the art. The support circuits 404 for the processor 401 include conventional cache, power supplies, clock circuits, data registers, I/O interfaces, and the like. The I/O interface 402 may be directly coupled to the memory 403 or coupled through the processor 401. The I/O interface 402 may be coupled to various input devices 412 and output devices 411, such as a conventional keyboard, mouse, printer, display, and the like.

The memory 403 may store all or portions of one or more programs, program information, and/or data to implement the functions of an RI, CI, or both an RI and a CI, or a DRM agent. Although the present embodiment is disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method of rights issuer authorization in a content distribution system, comprising:
receiving a message at client device from a first rights issuer;
obtaining a digital certificate for the first rights issuer;
processing the digital certificate to verify the first rights issuer as being rights issuer authorizing;
processing the message to identify at least one rights issuer identifier; and
configuring the client device to receive rights objects from at least one rights issuer corresponding to the at least one rights issuer identifier, respectively.

2. The method of claim 1, wherein the step of processing the digital certificate comprises:
parsing the digital certificate to determine whether a predefined field therein has a predefined value.

3. The method of claim 2, wherein the predefined field comprises an attribute in a subject name section of the digital certificate.

4. The method of claim 1, further comprising:
authenticating the message using a public key of the digital certificate.

5. The method of claim 1, wherein the message is a rights object acquisition protocol (ROAP) registration trigger message.

6. The method of claim 1, further comprising:
requesting an item of content;
requesting a rights object from a rights issuer of the at least one rights issuer;
receiving the item of content and the rights object; and
viewing the item of content using the rights object.

7. The method of claim 1, wherein each of the at least one rights issuer identifier comprises a hash of a public key for a respective one of the at least one rights issuer.

8. A content distribution system, comprising:
a network;
a plurality of rights issuers coupled to the network, the plurality of rights issuers including an first rights issuer having a digital certificate with a predefined field indicating that the first rights issuer is rights issuer authorizing; and
a client device, coupled to the network, for receiving a message from the first rights issuer, processing the digital certificate to verify the first rights issuer as being rights issuer authorizing, and parsing the message to identify at least one rights issuer identifier, the client device being configured to receive rights objects from at least one of the plurality of rights issuers based on the at least one rights issuer identifier.

9. The system of claim 8, wherein the client device is configured to parsing the digital certificate to determine whether the predefined field therein has a predefined value.

10. The system of claim 9, wherein the predefined field comprises an attribute in a subject name section of the digital certificate.

11. The system of claim 8, wherein the client device is configured to authenticate the message using a public key of the digital certificate.

12. The system of claim 8, wherein the message is a rights object acquisition protocol (ROAP) registration trigger message.

13. The system of claim 8, further comprising:
a content issuer;
the client device being further configured to:
request an item of content from the content issuer;
request a rights object from a rights issuer of the plurality of rights issuers corresponding to a rights issuer identifier of the at least one rights issuer identifier;
receive the item of content and the rights object; and
view the item of content using the rights object.

14. The system of claim 8, wherein each of the at least one rights issuer identifier comprises a hash of a public key for a respective one of the at least one rights issuer.

15. Apparatus for rights issuer authorization in a content distribution system, comprising:
means for receiving a message at client device from a first rights issuer;
means for obtaining a digital certificate for the first rights issuer;
means for processing the digital certificate to verify the first rights issuer as being rights issuer authorizing;
means for processing the message to identify at least one rights issuer identifier; and
means for configuring the client device to receive rights objects from at least one rights issuer corresponding to the at least one rights issuer identifier, respectively.

16. The apparatus of claim 15, wherein the means for processing the digital certificate comprises:
means for parsing the digital certificate to determine whether a predefined field therein has a predefined value.

17. The apparatus of claim 16, wherein the predefined field comprises an attribute in a subject name section of the digital certificate.

18. The apparatus of claim 15, further comprising:
means for authenticating the message using a public key of the digital certificate.

19. The apparatus of claim 15, wherein the message is a rights object acquisition protocol (ROAP) registration trigger message.

20. The apparatus of claim 15, further comprising:
means for requesting an item of content;
means for requesting a rights object from a rights issuer of the at least one rights issuer;
means for receiving the item of content and the rights object; and
means for viewing the item of content using the rights object.
